(19) United States
(12) Patent Application Publication
(10) Pub. No.: US 2013/0345603 A1
(43) Pub. Date: Dec. 26, 2013

(54) Medical Rehabilitation Device

(71) Applicant: PRESSURE AIR BIOFEEDBACK CC, Pietermaritzburg (ZA)

(72) Inventor: Andries Willem PIENAAR, Pietermaritzburg (ZA)

(21) Appl. No.: 13/645,400

(22) Filed: Oct. 4, 2012

(30) Foreign Application Priority Data
Nov. 15, 2011 (DE) 202011107911.6

(51) Int. Cl. A61H 99/00

(52) U.S. Cl. CPC A61H 99/00
USPC 601/23

(57) ABSTRACT

A medical rehabilitation device includes an inflatable body which is formed of a resiliently deformable, slightly elastic material, the exact configuration and construction of the body, however, being greatly variable. The body may be spherical, or elliptical, ovoid or even hemispherical in shape. A pressure monitoring unit is linked to the device and monitors changes in the internal pressure in the inflatable body in response to deformation of the body as a result of external pressure exerted on the body.

### REFERENCE TO RELATED APPLICATIONS

This application claims the priority of German utility model application No. 20 2011 107 911 U1, filed Nov. 15, 2011, the entire contents of which are incorporated herein by reference.

### FIELD OF THE INVENTION

The invention relates particularly to a device for conducting clinical and biomechanical muscle assessments on injured patients, and/or for testing comparative strength, power and endurance, both in relation to isotonic and isometric muscle exercises associated with exercising programmes and with rehabilitation programmes involving persons suffering from different forms of injuries or disabilities.

### BACKGROUND OF THE INVENTION

The importance of muscle testing for monitoring the effects of exercise and rehabilitation programmes, followed by sports persons and patients with different pathologies, has become clearly apparent. Equipment known as an isokinetic dynamometer is known to be used for the above purpose, but is extremely expensive. It is thus an object of this invention to provide means for conducting both isotonic and isometric muscle exercise testing, which is portable and more economical to use than an isokinetic dynamometer and which can provide clinically reliable and valid muscle assessment in response to a range of predetermined muscle exercises.

### SUMMARY OF THE INVENTION

According to the invention there is provided a medical rehabilitation device, which comprises an inflatable resiliently deformable body and which is inflatable to a predetermined internal pressure; and a pressure monitoring arrangement for monitoring changes in the internal pressure in the inflatable body in response to deformation as a result of external pressure exerted on the body.

The inflatable body may be shaped in any one of a variety of forms and sizes. The inflatable body may be of rubber, or a like material and, as such, may be slightly elastic. Still further, the inflatable body may include an outer body that has an inflatable bladder located therein.

The pressure monitoring arrangement may include any suitable pressure sensor or pressure gauge that is connected in communication with the internal space defined by the inflatable body via a flexible tube operatively connected to the inflatable body by suitable complementary connector formations.

In a particular embodiment of the invention, the pressure monitoring arrangement may include a pressure sensor that is arranged to be in communication with the internal space defined by the inflatable body, the pressure sensor including a transmitter transmitting signals containing data on the internal pressure in the inflatable body, which are received in use, by a remotely located processor which is associated with a receiver receiving the data-containing signals transmitted by the transmitter of the pressure sensor, the processor also being associated with a recordable medium that is operable to record pressure changes within the inflatable body during the performance of predetermined exercises on the inflatable body.

The pressure monitoring arrangement may comprise an electronically operable device that can be operatively connected to a processor, e.g. a computer or like device, to provide a visual and/or a printed record of pressure changes within the inflatable body.

The medical rehabilitation device may also include an air pump for inflating the inflatable body, the air pump typically being connected in line with the flexible tube that provides communication between the interior of the body and the pressure gauge or pressure sensor of the pressure monitoring arrangement.

### BRIEF DESCRIPTION OF THE DRAWINGS

The features of the medical rehabilitation device and the mode of use thereof are described in more detail hereinafter with reference to an example of a medical rehabilitation device, in accordance with the invention, which is illustrated in the accompanying diagrammatic drawings.

FIGS. 1A and 1B show a schematic view of a medical rehabilitation device, in accordance with the invention; and

FIGS. 2A, 2B and 3 to 8 illustrate schematically different individual muscle exercises that can be performed with the medical rehabilitation device of FIGS. 1A and 1B.

### DETAILED DESCRIPTION OF THE INVENTION

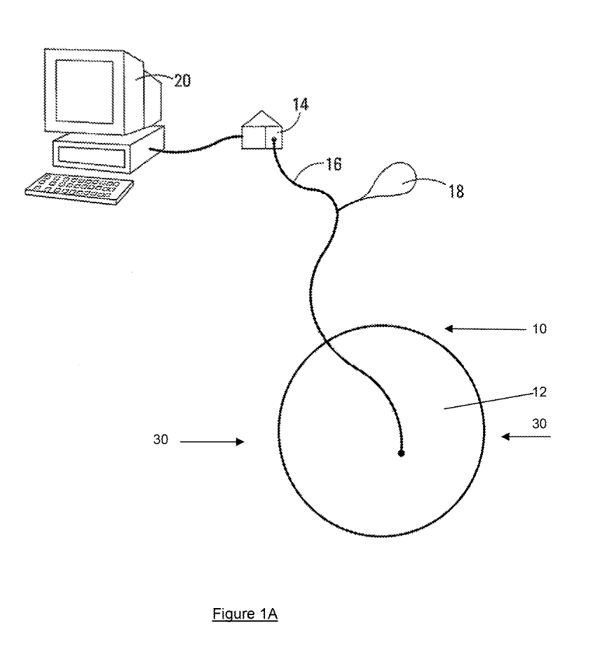

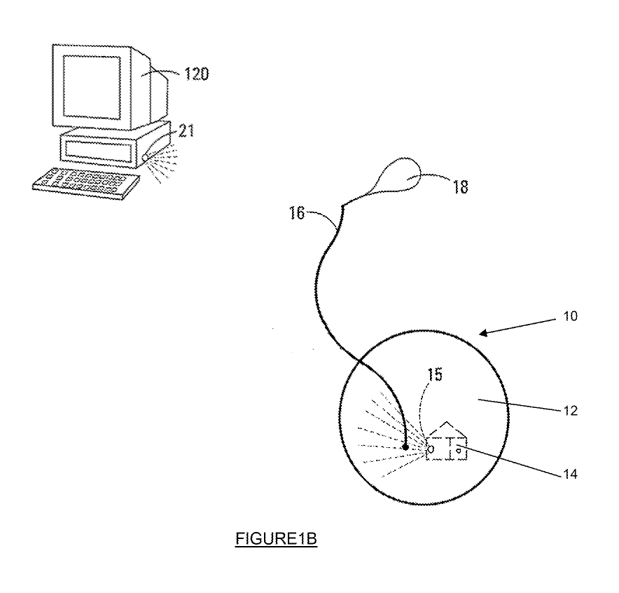

Referring initially to FIG. 1A of the drawings, a medical rehabilitation device in accordance with the invention is designated generally by the reference numeral 10. The medical rehabilitation device 10 includes an inflatable body 12 which is formed of a resiliently deformable, slightly elastic material, such as a rubber material, or the like, the exact configuration and construction of the body, however, being greatly variable. The body may be spherical, or elliptical, ovoid or even hemispherical in shape. In this embodiment of the invention, the body 12 is a spherical ball. It particularly is envisaged that the ball 12 may include an outer cover that has an inflatable bladder located therein.

The internal space defined by the ball 12 communicates with a pressure sensor 14 via a flexible tube 16 connected between the pressure sensor and the ball, the tube 16 being connected to the ball 12 via suitable complementary connector formations (not shown). An air displacement pump 18 further is connected in line with the tube 16, permitting inflation of the ball, particularly to required internal pressures, as explained in more detail hereafter.

The pressure sensor 14 is electronically operable and is connected to a computer 20 which permits a record of pressure changes in the ball, as sensed by the sensor 14, to be created, particularly in an image format and/or in a printed format.

It is envisaged also that a pressure sensor can be located on or within the ball in a configuration in which it can monitor the pressure therein, the sensor including a communicating device for communicating, e.g. by telemetric communication, with a remotely located computer for the purpose above explained.

Referring to FIG. 1B of the drawings, an alternative embodiment of a medical rehabilitation device in accordance with the invention is indicated generally by the reference numeral 10 and is similar to the medical rehabilitation device illustrated in FIG. 1A, with the exception that the pressure sensor 14 is located inside the ball 12 and includes a transmitting device in the form of a transmitter for transmitting signals containing data on the internal pressure within the ball 12. The signals are received by a remotely located processor in the form of a computer 120 which includes a receiving device 21 in the form of a receiver 21 for receiving the signals from the sensor 14.

Referring to either FIG. 1A or 1B, it will be understood that by applying compression forces in the direction of arrows 30 on the ball 12, the internal pressure within the ball 12 will change proportionally, the pressure sensor 14 and computer 20 providing for an accurate record of pressure changes to be generated. This permits isolated muscle testing for comparative strength, power and endurance, both in relation to isotonic and isometric muscle exercises, as illustrated and explained in more detail.

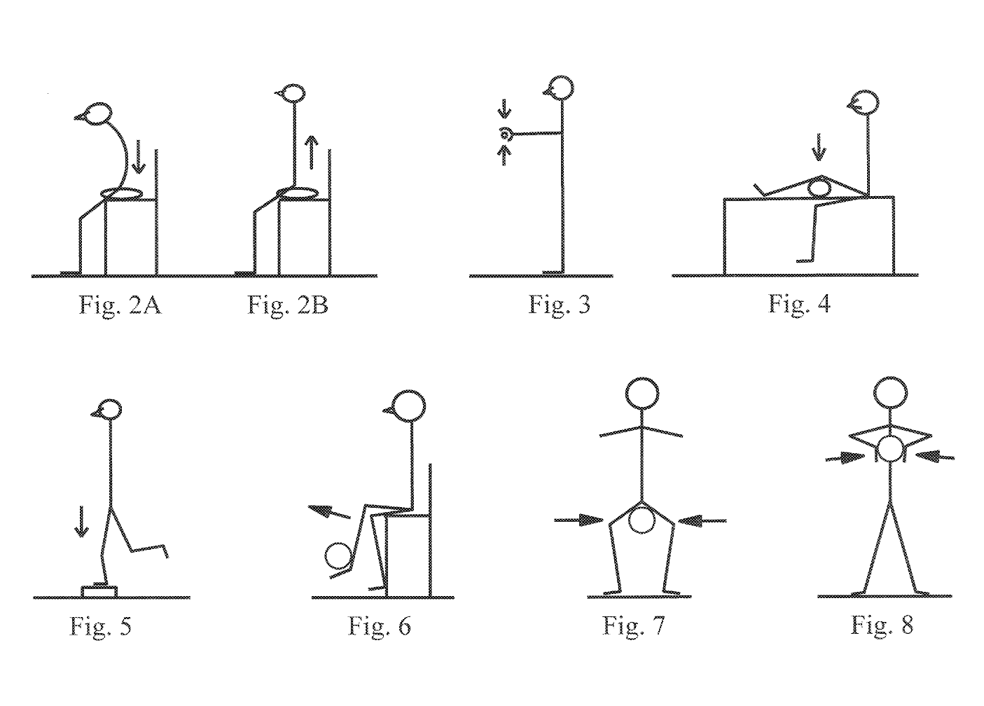

FIGS. 2 to 8 illustrate different muscle exercises that can be performed for conducting isolated muscle testing. Muscle exercises can be both isotonic exercises and isometric exercises. FIG. 2 particularly illustrates testing of the neutral spine posture by activation of the lumbar multifidus, iliocostalis lumborum and internal oblique muscles in the lumbar spine, whereas FIG. 3 illustrates testing of hand and finger grip strength by activation of extensor carpus radialis and ulnaris, flexor carpus radialis and ulnaris as well as the brachioradialis muscle. FIG. 4 illustrates testing of the vastus medialis oblique, rectus femoris and vastus lateralis muscles, whereas FIG. 5 illustrates testing of neuromuscular proprioceptive control by means of 1 leg balancing. FIG. 6 illustrates a kick ball test for testing leg power, whereas FIG. 7 illustrates testing of the adductor muscles in a person's thigh and FIG. 8 illustrates testing of the pectoralis muscle in the chest.

In a further alternative embodiment of the invention, a pressurising strap with handles may be secured around the circumference of the ball, to allow tension (pulling) forces to be exerted on the ball, thus allowing the testing of other muscle groups.

By pressurising the ball 12 to a predetermined pressure, as determined by the exercise to be performed, and by monitoring pressure changes within the ball of the medical rehabilitation device of the invention, individual exercise performance can be accurately monitored and controlled. By comparing performances at intervals, the rehabilitation of muscles can be effectively monitored and controlled.

The medical rehabilitation device of the invention clearly constitutes a portable device that can provide for clinically reliable and valid muscle assessment in response to exercises being conducted with the aid of the device in a relatively simple and economical fashion. The medical rehabilitation device can be used effectively in relation to exercise and rehabilitation programmes as are commonly followed by both sports persons and by patients suffering from different forms of injuries or disabilities.

1. A medical rehabilitation device, comprising a body of resiliently deformable material inflatable to a predetermined internal pressure and a unit monitoring the variations in internal pressure in the body in response to deformation of the body as a result of external forces operating on the body.

2. A medical rehabilitation device as claimed in claim 1, wherein the device is adapted so that the deformation of the body occurs as a result of exercises performed on the body by a user

3. A medical rehabilitation device as claimed in claim 1 or 2, wherein the body is made of rubber or a rubber-like material.

4. A medical rehabilitation device as claimed in claim 1 or 2, wherein the body comprises an outer body that has an inflatable bladder located therein.

5. A medical rehabilitation device as claimed in claim 1 or 2, wherein the pressure monitoring unit comprises a pressure sensor that is connected in communication with the internal space defined by the body via a flexible tube operatively connected to the body by suitable complementary connector formations.

6. A medical rehabilitation device as claimed in claim 1 or 2, wherein the pressure monitoring unit comprises a pressure sensor that is arranged to be in communication with the internal space defined by the body, the pressure sensor including a transmitter for transmitting signals containing data on the internal pressure in the body to a remotely located processor which is associated with a receiver for receiving the data-containing signals transmitted by the transmitter of the pressure sensor, the processor being associated with a recordable medium that is operable to record pressure changes within the body during the performance of predetermined exercises on the body.

7. A medical rehabilitation device as claimed in claim 1 or 2, wherein the pressure monitoring unit comprises an electronically operable device operatively connected to a processor to provide a visual or a printed record of pressure changes within the body during the performance of predetermined exercises on the body.

8. A medical rehabilitation device as claimed in claim 5, wherein the device includes an air pump for inflating the inflatable body, the air pump being connected in line with the flexible tube that provides communication between the interior of the body and the pressure gauge or pressure sensor of the pressure monitoring unit.

9. A medical rehabilitation device as claimed in claim 4, wherein the pressure monitoring unit comprises a pressure sensor that is connected in communication with the internal space defined by the body via a flexible tube operatively connected to the body by suitable complementary connector formations.

10. A medical rehabilitation device as claimed in claim 4, wherein the pressure monitoring unit comprises a pressure sensor that is arranged to be in communication with the internal space defined by the body, the pressure sensor including a transmitter for transmitting signals containing data on the internal pressure in the body to a remotely located processor which is associated with a receiver for receiving the data-containing signals transmitted by the transmitter of the pressure sensor, the processor being associated with a recordable medium that is operable to record pressure changes within the body during the performance of predetermined exercises on the body.

11. A medical rehabilitation device as claimed in claim 4, wherein the pressure monitoring unit comprises an electronically operable device operatively connected to a processor to provide a visual or a printed record of pressure changes within the body during the performance of predetermined exercises on the body.
